(19) United States
(12) Patent Application Publication
(10) Pub. No.: US 2004/0025173 A1
(43) Pub. Date: Feb. 5, 2004

(54) Interaction abstraction system and method

(76) Inventors: Gil Levonai, Winchester, MA (US); Oren Minzer, Cambridge, MA (US); Adi Dulberg, Brookline, MA (US); Alex Toker, Ramle (IL)

Correspondence Address: William H. Dippert, Esq., Reed Smith LLP, 29th Floor, 599 Lexington Avenue, New York, NY, 10022-7650, US

(21) Appl. No.: 10/422,357

(22) Filed: Apr. 24, 2003

Related U.S. Application Data
(60) Provisional application No. 60/375,375, filed on Apr. 24, 2002.

(51) Int. Cl. G06F 9/00

(52) U.S. Cl. 719/328

(57) ABSTRACT

An abstraction unit, comprising a conversion module adapted to translate general instructions, having a format that is independent of a target device model, to specific instructions for each of a plurality of different target device models, said module having at least one programmable and user accessible rule element which defines said translation; and a presentation module adapted to receive responses from a plurality of said target devices, said module having at least one programmable and user accessible rule element which converts said responses into a standardized response format that is independent of the device model that sent the response.

### RELATED APPLICATIONS

The present application claims the benefit under 35 U.S.C. §119(e) of U.S. provisional application of same title filed on Apr. 24, 2002 and having a Ser. No. of 60/375,375, the disclosure of all of which is incorporated herein by reference.

### FIELD OF THE INVENTION

The present invention relates to interacting with embedded devices using a unified programming interface.

### BACKGROUND OF THE INVENTION

Embedded processors are employed in many different devices, such as cellular phones, personal organizers, network switches, medical equipment, household appliances (washing machines, televisions), and automobiles. These devices include hardware which is operated by software code run on the embedded processor. During the design, manufacture and/or operation of the devices, it is desired to have the ability to debug and monitor the software code running on the embedded processor.

Generally, when programmers prepare software code for embedded processors they include in the software routines which are used to gather data for debugging and troubleshooting. In some cases, various data gathering commands (for example implemented as positive commands or as self activating hooks which are implanted throughout the software code), are provided in the embedded device. In other cases, a device may include a maintenance mode for performing maintenance related data gathering and/or other tasks. During normal operation of the software, the data gathering commands do nothing (except possibly determining that there is no need for data gathering). Under an external command of a maintenance person, however, the data gathering commands are operated and they transmit data to a remote monitoring station. In some systems, the data gathering commands are organized in groups for different purposes. For example, different groups of data gathering commands may be provided in the software code for use in different failure situations. When a problem arises, the maintenance person activates commands from a specific group of data gathering commands. The maintenance person then reviews the information and may perform various analyses on it.

When a large number of different, possibly similar, devices need to be monitored by a single maintenance person, it is often the case that each device (from a same or different manufacturer) uses different commands, modes and/or data formats for providing maintenance related information. The maintenance person is thus required to be familiar with the maintenance specifics of many devices.

### SUMMARY OF THE INVENTION

An aspect of some embodiments of the invention relates to apparatus and method for interacting with a large plurality of differently functioning embedded devices, The number of devices may be, for example 100, 1000, 10000, 100000 or a greater, smaller or intermediate limber of devices. The number of different functioning devices may be, for example, 5, 10, 30, 100, 1000 or a greater, smaller or intermediate number of device types with different function. The devices may all belong to a same family of devices (e.g., cellular telephones) or belong to different families (e.g., refrigerators, cellular telephones, routers, telephone exchanges), for example, 3, 75 10, 20 or any smaller intermediate or greater number of device families. In an exemplary embodiment of the invention, a device comprises a network of devices and/or a hierarchical organization of devices.

In an exemplary embodiment of the invention, the interaction is for maintenance purposes, for example, requesting data from the devices. Alternatively, the interaction may be of other kinds, for example as described below. It is noted however, that the problem of interaction is especially difficult for regular maintenance, where a single maintainer may use devices from many different manufactures and/or production lines and whose maintenance is no longer supported by the manufacturers (e.g., legacy systems). Often, maintenance-related software is produced dedicated for a device or a small set of devices and then is not updated or otherwise supported, as soon as a new model comes out. Where there is only a small number of such devices, it may be possible to find a service provider (or a few) that can handle those devices. When the numbers of devices multiply it becomes very difficult. On the converse side, the inventors have determined that there is often some commonality between devices, for example, with regard to failure modes, preventive maintenance and/or failure determination. In an exemplary embodiment of die invention, this commonality is used to provide a system in which similarity between devices is used to facilitate maintenance, possibly by the owner and not the manufacturer.

In an exemplary embodiment of the invention, the interaction is facilitated by providing an abstraction layer between the devices and an actor (e.g., human or machine) interacting with the devices. In an exemplary embodiment of the invention, the abstraction layer allows an interaction application or actor to deal with a virtual device, rather than a particular physical device. In an exemplary embodiment of the invention, a maintenance system comprises a relatively generic maintenance unit that focuses on maintenance in general and an abstraction layer unit that translates general maintenance-related device instructions into specific device instructions. This allows, for example in some embodiments of the invention, a maintenance application to generate a data collection command which will be correctly translated and its results analyzed and then returned to the maintenance application, substantially independent of the particular device being maintained. The maintenance logic can then be separated from the performance of the maintenance instructions, potentially making the maintenance logic easier to write and update.

In an exemplary embodiment of the invention, the abstraction layer includes an instruction converter which converts general instructions into specific instructions understandable by the particular target devices.

Alternatively or additionally, the abstraction layer includes a data analyzer which analyses the data returned by the particular devices, to generate an output for the actor. The analysis may include, for example, combining data from different specific instructions and determining what data is presented and/or how, if it is presented. In an exemplary embodiment of the invention, the data analysis comprises categorizing the data by type. Optionally, this categorizing is used to link the abstraction of the devices with the maintenance application. Alternatively or additionally, tie data analysis, logic, action and/or display comprise accumulating data for historical processing. There is optionally a separation between the collection of information from target devices and the analysis of the information.

Optionally, the abstraction layer includes a data processor which processes the returning data, for example, filtering out the data and selecting which of the returned data items is the one needed. The output of the data processor may be sent to the data analyzer.

In an exemplary embodiment of the invention, the output of the abstraction layer (e.g., the data analyzer) is used by an automated maintenance system, for providing maintenance for the devices. As noted above, the maintenance system can include maintenance logic (e.g., in the form of rules, scripts, software) in which the device's functionality is dealt with as an abstraction and not as a large number of different particular instances.

This and other programmable logic is referred to herein using the generic term “rules”, as in an exemplary embodiment of the invention the logic is embodied as a set of pattern-action type rules. While the term “rules” is used, various equivalent schemes are intended to be included in this term, for some embodiments of the invention, for example, scripts, neural networks, compiled software, decision tables and/or state machines, all of which have the property of describing a course of action to carry out in certain situations. Where actual rules are meant, the term “rule statements” is used.

In an exemplary embodiment of the invention, the abstraction layer is programmable, for example using rules to define the behavior of the apparatus in various situations. In an exemplary embodiment of the invention, the rules are set by the user of the apparatus, rather than by the manufacturer of the device. In an exemplary embodiment of the invention, the rules are arranged so that the abstraction of the devices is hierarchical, for example, with different device types having different meta-sets of rules associated with them. Within each device type, the rules for each device may be different. However, not all the rules need be different. For example, data collection rules and data processing rules may be the same for devices made by a same manufacturer. Alternatively or additionally, data processing rules may be shared by devices by different manufactures which have a similar functionality.

In an exemplary embodiment of the invention, the abstraction and/or maintenance apparatus is flexible with regard to its operation. In some embodiments, this flexibility is provided by the separation of the apparatus into separate components and/or by the provision of a non-programming user interface to define the various rules used. For example, to add a new device to be maintained, providing instruction conversion rules or data processing rules may be sufficient. Such rules can be provided based on a reading of the user manual, by a user of the device (e.g., uploading a device definition to the system) or by the maintainer, and does not generally require special programming skills or in-house knowledge of the device manufacturer. Further, in an exemplary embodiment of the invention, the rules are open, in that they do not impose many limitations on their use. Thus for example, data processing rules can be used to interact with a specialized standard, such as SNMP, or with a text output by the maintained device. Data analysis rules allow various differences between the device's reporting functionality to be bridged, for example generating historical averages, where the device does not generate such averages. Instruction conversion rules, for example, allow overcoming the differences between a device with hooks, a device using data gathering commands and/or a device with a dedicated maintenance mode and/or to emulate complex data interfaces and gathering profiles.

Some embodiments of the invention may be better understood by contrasting them with existing schemes for interacting with multiple different devices.

One type of existing scheme, which may bear some passing resemblance to sortie embodiments of he invention, is operating systems. Operating systems typically come with a set of drivers, for example, 10 different drivers for 10 different types of disk drives. However, these drivers are generally provided by the manufacturer of the disk drives. Further, the output of the drivers to the operating system is rigidly enforced to meet the system calls defined in the operating systems, possibly causing some device functionality to be unavailable or inconvenient to access, simply because the operating system calls do not support it. Also, the drivers are not generally programmable and require a special expertise to generate, due to their complexity. In general, there is no flexibility within each family of devices supported by the operating system, while different families of devices have different rigidly defined specifications for interacting with the operating system.

Another somewhat similar scheme is that of a gateway, which translates packets between different network protocols. In general, the definitions of a gateway are hard-wired and network properties cannot be varied beyond parameter setting. In addition, the gateway typically defines strict definitions and enforces them, on the data passing through the gateway. There is no possibility of flexibility and, often, network functions are lost when using a gateway.

Another somewhat similar scheme is that of a simulation system in which multiple objects and sensors are emulated by the system. While each such object and sensor may be defined in a flexible maimer, generally, a same command is not conveyed to each object/sensor and then translated into particular instructions for the sensor, nor is the returned data analyzed in an abstraction layer. Further, calibration and/or other maintenance related tasks, which are optionally performed using a method of the present invention, are not applicable to simulation systems.

As used herein, the term “maintaining” refers to support activities that relate to failure states, for example, including the prevention, avoidance, diagnosis and/or solution of failure states in a device. A failure may be caused by internal and/or external agents, for example due to wearing out or failure of components, incorrect design, use outside of design specifications, bad input of data or instructions and/or malicious activity. Maintenance relating activities, include, for example, configuration control, asset management, calibration and initial setup (in some cases). In general, maintenance is separated from operation by the operations attempting to use the device for its intended (or novel) purpose, while maintenance and maintenance related activities attend to the device itself, for its own sake or for the sake of other devices.

An aspect of some embodiments of the invention relates to the categorization of data collected from the monitored devices, for example by the abstraction layer or later in the chain of processing. In an exemplary embodiment of the invention, the categorization is used to determine further treatment of the data, for example, storage, analysis, and display. Optionally, the categorization serves to bridge between the general abstraction layer and the maintenance application. Optionally the categories overlap and/or a single datum may be provided with two categories. A same datum may be categorized differently based on a reason and/or way in which it was collected and/or based on an expected later use.

An aspect of some embodiments of the invention, relates to an abstraction method for maintaining of devices, in which the sharing of features and/or functionality and/or maintenance-aspects between devices is used. In one example, devices are represented as having objects (e.g., sub-components), each of which have properties, for example, 3, 7, 10, 30 or any smaller, larger or intermediate number, each (non-indexed). In an exemplary embodiment of the invention, the properties overlap between devices, for example, two devices of a same device type having a 100%, 90%, 80% or any smaller, or intimidate overlap of properties. In some cases, however, the properties are not associated with the same objects and/or collected in the same way, even for same type devices. Device families, a typically higher abstraction level, (e.g., home appliances, network elements) may have a lower degree of overlap, for example, 60%, 40%, 20% or any smaller or intermediate overlap degree. Similar overlaps may be provided between objects. In general, the overlap for objects is lower than for properties, since different devices often have a different inner design.

These properties are optionally arranged in a small number of categories associated with maintenance tasks, for example, 3, 6, 8 or any smaller, intermediate or larger number of categories, possibly these number being used for all device types and/or families. In general, more than two or more than three properties are provided in a category. In an exemplary embodiment of the invention, the category determines how a property is dealt with, possibly irrespectively of the property type and/or the property value.

Rules may also be shared (or copied), between objects, properties and/or devices. Different share levels may be provided for different rule types, for example, depending on the abstraction level of the rules. For example, for a given rule type, there may be an overlap of 10%, 20%, 40% or any smaller, intermediate or larger percentage between two properties, objects, devices and/or device families.

An aspect of some embodiments of the invention relates to a method of adding a device to be maintained to a maintenance server. In an exemplary embodiment of the invention, the method comprises determining which maintenance instructions of the server are relevant to tie device. This may be done, for example, based on a device type list. From this instruction, all instructions that can be carried oat by the device are optionally identified. For each such instruction, a definition is made of one or more device-specific instructions that will return the desired maintenance data and/or otherwise perform a desired maintenance action. A translation rule from the general instruction to the specific instruction(s) is generated, optionally by selection on a graphical user interface. Optionally, the format of data returned by the instructions is analyzed and a filter rule is defined that extracts the desired return data. Optionally, one or more analysis rules are defined to convert the data into data expected by the maintenance server. In some cases, rules or sets of rules are copied from one or more devices to a new device (e.g., rules form an earlier model of a same manufacturer). Such rules are optionally modified using the interface and/or rules added or deleted.

An aspect of some embodiments of the invention relates to auto-discovery and/or configuration of a support network. In an exemplary embodiment of the invention, a support network comprises a plurality of supported devices that receive maintenance services by and/or through one or more site servers. If such a network includes a large plurality of devices, for example, different devices, setting up a network configuration may be time consuming. In an exemplary embodiment of the invention, a site server (and/or other maintenance providing unit and/or an abstraction layer unit) generates/learns some or all of the network parameters by itself. In an exemplary embodiment of the invention, a user (or other entity, such as a network management system) provides device IP addresses for all the devices and the maintenance unit contacts the devices. Based on responses to queries sent by the maintenance unit, it determines, for example, one or more of device type, preferred protocol, initial status and/or device version. In an exemplary embodiment of the invention, as a result of such determination, the maintenance providing unit sets up various abstraction rules (e.g., provided to an abstraction server) and/or maintenance rules (e.g., for the unit itself).

An aspect of some embodiments of the invention relates to provision of bookkeeping services by a maintenance unit and/or an associated abstraction layer unit, rather than by a user. Often, a substantial part of a programming task is such bookkeeping activities as keeping track of variables and ensuring that a data item is available before attempting to do processing using that data item. In an exemplary embodiment of the invention, provision of such bookkeeping functions assist a user in defining maintenance protocols and may enable a non-programmer, non-vendor, to define abstraction rules and/or maintenance rules. In an exemplary embodiment of the invention, the abstraction rules are written as rules, not program-like sequences of commands.

In an exemplary embodiment of the invention, the book-keeping includes dynamic indexing, in which, when a device has multiple instances of a property, the maintenance unit keeps track of the instances by generating a dynamic index. Optionally, the maintenance unit also attends to acquiring an up-to-date list of the instances. In one example, a device includes multiple ports. A request by a user to provide an average port throughput comprises a rule that port list is acquired by a first command, that a port throughput (for a port) is acquired by a second command. The maintenance unit, runs the first command to get a list of port and executes the second command on all the ports in the list. Any port that does not respond is dealt with by attempting to re-contact only that port and/or other error activity that may be defined. Optionally, any port that has a throughput greater than 50 KB/sec is queried for additional information, for example bit error rate.

There is thus provided in accordance with an exemplary embodiment of the invention, an abstraction unit, comprising:

a conversion module adapted to translate general instructions, having a format that is independent of a target device model, to specific instructions for each of a plurality of different target device models, said module having at least one programmable and user accessible rule element which defines said translation; and

a presentation module adapted to receive responses from a plurality of said target devices, said module having at least one programmable and user accessible rule element which converts said responses into a standardized response format that is independent of the device model that sent the response. Optionally, said presentation module comprises parsing rules that extract a desired item from said responses, to form said standardized response. Alternatively or additionally, said rule elements comprise sets of rule statements.

In an exemplary embodiment of the invention, the unit comprises a maintenance unit that performs maintenance on said devices through said abstraction unit by providing said general instructions and receiving said standardized response. Optionally, said maintenance unit is implemented using maintenance rule statements.

In an exemplary embodiment of the invention, said presentation module categorizes said responses, according to their type, into a number of categories, said number being smaller than each of a number of said target device models and smaller than a number of different properties defined for the devices. Optionally, said categories determine for a standardized response which of a plurality of sets of rules are applied to the response.

In an exemplary embodiment of the invention, the unit comprises an analysis module that analyses said standardized response to produce maintenance-related information. Optionally, said analysis module generates at least some response data that is requested by said general instructions and not directly provided in said responses.

In an exemplary embodiment of the invention, the nit comprises a bookkeeping module for tracking device property values for said devices. Optionally, said bookkeeping module generates dynamic indexes of elements of said target devices that have multiple instances in a target device. Optionally, said bookkeeping module automatically updates a listing of said multiple instances.

In an exemplary embodiment of the invention, the unit comprises a storage module which stores data from at least one of said responses and said standardized response, responsive to at least one storage rule.

In an exemplary embodiment of the invention, said target devices are modeled by said unit as hierarchical devices, with sub-components which are allowed to be repeated between different devices. Optionally, different sub-components are treated differently in said standardized response. Optionally, different sub-components have different rules associated with them.

In an exemplary embodiment of the invention, said unit is adapted to connect to multiple target devices at a same local physical site as said unit.

In an exemplary embodiment of the invention, said unit is adapted to connect to multiple target devices at a physical site remote from said unit.

In an exemplary embodiment of the invention, said unit is adapted to connect to a remote maintenance server.

In an exemplary embodiment of the invention, said unit is adapted to connect to a remote vendor server that accesses only devices from a limited number of device manufacturers.

In an exemplary embodiment of the invention, said unit is adapted to simultaneously serve multiple target devices belonging multiple device families. Optionally, said unit is adapted to connect to at least 3 different device family types. Alternatively or additionally, said unit is adapted to connect to at least 5 different device types. Alternatively or additionally, said unit shares at least one rule between said multiple target devices.

There is also provided in accordance with an exemplary embodiment of the invention, a maintenance device system, comprising:

a plurality of target devices;

at least one abstraction unit, physically locally situated at a same site with respect to said plurality of devices; and

at least one maintenance server physically remotely situated at a different site with respect to said abstraction unit and configured to provide maintenance services to said target devices via said abstraction unit. Optionally, the system comprises at least one vendor server configured to communicate with multiple abstraction units in multiple sites. Alternatively or additionally said maintenance server is configured to provide maintenance services to multiple remotely located sites.

There is also provided in accordance with an exemplary embodiment of the invention, a method of maintaining a plurality of objects, comprising:

generating maintenance instructions using a maintenance unit that models devices as abstract devices; and

converting said instructions into device specific instructions using an abstraction unit that views said devices as specific devices.

There is also provided in accordance with an exemplary embodiment of the invention, a method of adding a device to be maintained, to a maintenance system, comprising:

identifying a device type of said new device to be added;

copying at least one abstraction rule from an existing device rule set portion to a rule set portion of a representation of said new device; and

amending said rule set of said new device for said specific device after said copying.

There is also provided in accordance with an exemplary embodiment of the invention, an abstractive maintenance system, comprising:

an automated maintenance providing unit that models devices as abstract devices; and

an abstraction unit that models said devices as specific devices and interfaces between said devices and said maintenance unit.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic block diagram of a monitoring configuration of an embedded device, in accordance with an embodiment of the present invention;

FIG. 2 is a schematic diagram of an abstraction model of an embedded device, in accordance with an embodiment of the present invention;

FIGS. 3 is a flowchart of acts performed in preparing for monitoring an embedded device, in accordance with an embodiment of the present invention; and

FIG. 4 is a flowchart of acts performed by an abstraction translation unit, in accordance with an embodiment of the present invention.

### DETAILED DESCRIPTION OF EMBODIMENTS

### Configuration Overview

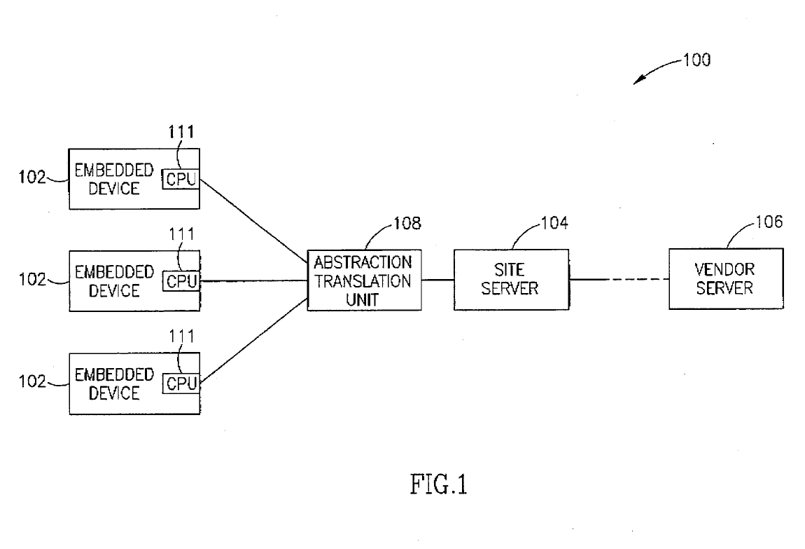

FIG. 1 is a schematic block diagram of a monitoring configuration 100, in which one or more embedded devices 102 are monitored by a maintenance server, such as a site server 104, in accordance with an exemplary embodiment of the invention. The plurality of devices 102 need not be the same type, manufacture, model and/or version. In an exemplary embodiment of the invention, an abstraction translation unit (e.g., as a software and/or hardware front end) 108 is provided between site server 104 and devices 102, to regularize and/or otherwise control the way the devices are viewed and/or dealt with by server 104. In an exemplary embodiment of the invention, the number of devices is very large, for example, thousands or millions of devices.

While various variations are described below, for example with respect to the type of device 102 and the topography of the site server and/or intermediate units between server 104 and devices 102, many principles of the operation of some embodiments of the invention may be presented using the simplified structure of FIG. 1. In an exemplary embodiment of the invention, embedded device 102 comprises an embedded processor 111 which runs software that controls the device. Embedded device 102 may be substantially any apparatus that employs an embedded processor. Such processors (and/or the device) typically require debugging, logging and/or maintenance. For example, embedded device 102 may be a router (or any other network element), factory machine or home appliance.

In an exemplary embodiment of the invention, processor 111 executes not only software routines that control embedded device 102 but also maintenance routines that perform debugging, monitoring and/or logging operations. The maintenance routines may include proprietary routines written specifically for the specific embedded device 102 or may include generic maintenance routines, as described for example in WO 01/59971, the disclosure of which is incorporated herein by reference. It should be appreciated that many different modes for executing such routines exist.

In an exemplary embodiment of the invention, site server 104 communicates with the maintenance routines on processor 111, providing the maintenance routines with operation instructions and/or receiving from the maintenance routines data they gathered. Site server 104 allows a maintenance person of a site employing embedded device 102 to perform maintenance, debugging and/or logging tasks for embedded device.

### Abstraction Model

In some embodiments of the invention, abstraction translation unit 108 acts to represent devices 102 as abstract entities to site server 104. To this end, generic instructions are provided by site server 104 and are translated into device-specific instructions by translation unit 108, optionally using one or more conversion rules (described below). Data returned by devices 102 is optionally processed to extract information of interest, optionally analyzed and passed to site server 104, optionally in a standardized presentation format, which can, for example, perform maintenance-related analysis on the data. Optionally, a device model is arranged as a hierarchical structure, e.g., a tree, with the returned information at the leaves. Optionally, a device model has another dimension, that of categories, for example with different properties belonging to different categories and the categories determining which rules to apply.

In an exemplary embodiment of the invention, site server 104 views devices 102 as virtual devices, rather than as real, specific, instances of devices.

In an exemplary embodiment of the invention, the total software architecture including the abstraction model is designed so that it is modular. In an exemplary embodiment of the invention, the modules are selected to define a hierarchy of levels so that it level is to a great degree independent (and/or has clear interfaces) from the other levels. Alternatively or additionally, the design (e.g., through categorization of rules) further fragments the operations of the system so that each fragment is relatively independent (and/or has clear interfaces) of other fragments. This may assist in changing the contents of the levels and/or parts of each level. Alternatively or additionally, the design collects certain elements that are expected to be changeable for various uses, in centralized locations, which are optionally user accessible.

In an exemplary embodiment of the invention, user accessible means relative ease in changing a portion of the system. The ease may be exhibited, for example in a clear location and format of changes to make and/or not requiring recompilation of the system and/or of parts of it. Alternatively or additionally, the ease may be exhibited by the changes not having (or having fewer) far-reaching side effects. Alternatively or additionally, the ease is exhibited in the provision of a simple user interface and/or avoiding the need for programming. Alternatively or additionally, the ease is exhibited in a user being able to work in abstractions, for example being able to copy, inherit, modify and/or combine parts of the system to create a new part.

There are various potential advantages to such an abstraction model, including, for example, one or more of:

(a) ease in adding or changing devices;

(b) potential independence from device vendors;

(c) independent development and upgrading of different system parts;

(d) tailoring of a system or a system portion to a specific need and/or maintenance type; and/or

(e) hiding information about the devices, e.g., configuration, number and type (including specific proprietary information).

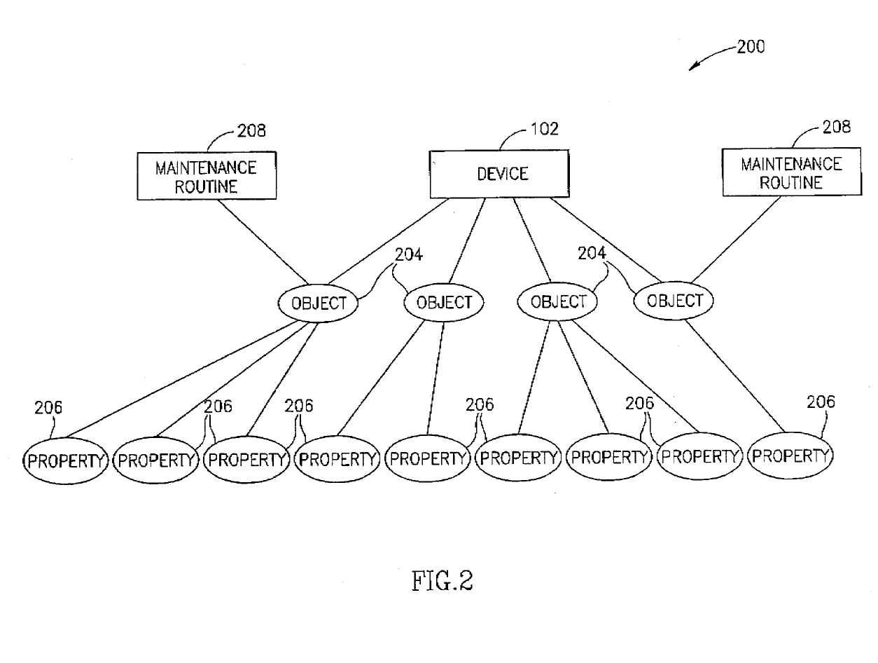

FIG. 2 is a schematic diagram of an abstraction model 200 of an embedded device 102, in accordance with an embodiment of the present invention. In accordance with model 200, each device 102 is formed of one or more parts, referred to herein as objects 204. A router device, for example, may include as objects 204, ports, VLANs and/or ATM connections. Each of the objects 204 generally has one or more properties 206, which are variables of interest to maintenance personal related to the object. The properties may include, for example, traffic counters, CPU load, temperature, pressure, speed, etc., depending on the specifics of the object. In some embodiments of the invention, each object 204 may appear one or more times in the device 102. Optionally, different instances of a same object 204 are identified by an index value of the object, which may be dynamically generated, for example as described below. As noted above, properties and/or objects may be associated into categories. In some embodiments of the invention, the categorization depends on a device state and/or a property value.

In an exemplary embodiment of the invention, the model is hierarchical, for example, devices arranged into meta devices (e.g., virtual circuits) and/or divided into sub-components, for example {PC=motherboard, storage, interface}; {motherboard=CPU, cache}; {CPU having load property and speed property}.

In an exemplary embodiment of the invention, a model is not merely a representation of a device, but a representation which optionally assists in regularization of interaction with diverse devices and/or a representation that assists in defining commonality between devices. To this end, the properties and/or objects may be defined in a manner which reflects their intended use (e.g., maintenance) and/or to match a model used by a maintenance server (e.g., a tree-like representation of virtual devices to be maintained). Alternatively or additionally, virtual properties may be defined, which cannot be provided by the devices, but may, for example, be calculated based on reporting by tee devices. In one example, a single property required by a maintenance routine is translated into different physical (and/or virtual) properties and instructions by the abstraction unit, for different physical devices.

In an exemplary embodiment of the invention, the model includes one or more sets of rules, which define abstracting and/or specifying actions. The rules may be defined, for example, as part of the model and/or when a new device is added. For example, one or wore of the following sets of rules may be defied:

(a) conversion rules;

(b) collection profiles;

(c) processing rules, optionally including parsing rules;

(d) analysis rules;

(e) maintenance rules;

(f) storage rues; and

(g) display rules.

### Conversion Rules

In an exemplary embodiment of the invention, conversion rules include instructions for converting from high-level instructions, such as “get CPU load” into device specific is instructions such as “code 0xA8”. In some cases, a single instruction will translate into multiple instructions, for example, get CPU load may be performed on a particular device by performing a sequence of commands. Alternatively or additionally, a single instruction may be performed on a virtual property, for example if the device does not report CPU load it may be estimated by executing several other commands and analyzing their results. In another example, the collection is performed previously to the abstraction unit receiving any particular instruction and/or previously to the unit sending any instruction (e.g., self-logging) and the instruction actually carried out is analyzing historical data by the abstraction unit.

In an exemplary embodiment of the invention, the conversion rules also handle converting tile instruction into a correct communication protocol.

In an exemplary embodiment of the invention, a conversion rule also includes an indication of the processing and/or analysis rules to be carried out on the return data to respond to a high level query.

### Collection Profiles

The collection profiles indicate sets of one or more properties which are to be logged. Such profiles may also include, for example, times at which data is to be logged and/or events at which to log. Optionally, the collection profile includes an indication of whether it is to be activated by a user, responsive to an event generated by a different collection profile and/or in accordance with a predetermined tiring scheme. The turning scheme may be a one time scheme and/or a repeated scheme, e.g., every 2 hours, at 6 PM each day and/or relative to an event, e.g., 1 minute before a failure, ten times, every hour, after a failure.

In some embodiments of the invention, the collection profile indicates the number of times the property values are to be collected in each activation. For example, the property values may be collected once, for a predetermined number of times at a specific rate and/or continuously until receiving a termination instruction.

### Processing Rules and Parsing Rules

The data returned by the devices may be of various formats and/or returned in various protocols. For example, one device may return CPU load as a single 8 bit value. Another, as the second 16 bit word in a stream of 10 words. A third, as a text string. A fourth, as two numbers that need to be combined. In some cases, even a same device will return an answer in different formats, based on its operational mode.

In an exemplary embodiment of the invention, the processing rules describe how to retrieve the data of interest and/or perform basic processing, for example for converting the data to a standard format. For example, the processing rules can convert a returned datum to a desired representation, extract a particular filed (or fields) from a return stream, extract and convert data from plain text streams and/or combine two returned values (of a single or more than one data collection instruction), for example by adding or dividing the numbers.

It should be appreciated that the provision of general rules for parsing rather than bard wired methods, allows, in an exemplary embodiment of the invention, many different interaction methods with devices, for example, using text maintenance modes, using embedded hooks and/or using vendor pre-defined maintenance routines.

In an exemplary embodiment of the invention, a device returns all its data tagged, so processing rules may be omitted, with the data simply identified and handled according to its tag.

### Analysis Rules

While the processing rules generally extract and reformat data, analysis rules are used to analyze the data and/or perform more advanced processing, for example to respond to high-level queries. For example, analysis rules can determine a potential failure state based on results from multiple calls, and in response generate an alarm. In another example, analysis rules are used to generate data for virtual properties. Such virtual properties may be treated like real properties (or may be real properties), except that data for the properties is not, generally, acquired using a single call.

In some embodiments of the invention, analysis rules are associated with the properties to which they relate, such that each time the value of the associated property is collected, the analysis rule is applied. Alternatively or additionally, analysis rules may be applied periodically and/or responsive to a human trigger or a system event, for example to analyze historical data.

In an exemplary embodiment of the invention, analysis rules when violated (e.g., port status out of bounds) can trigger the execution of a collection rule.

In an exemplary embodiment of the invention, an analysis rule performs based on previously acquired and/or analyzed information on a device, for example, different analysis rules may be provided based on a device status that was previously collected. The abstraction unit optionally includes a database of such information values. The rules and the rest of the model are also optionally stored in a database.

In an exemplary embodiment of the invention, an analysis rule compares values from different calls, properties, operational modes and/or devices.

It should be noted that the defining line between analysis rules and maintenance rules may be blurred in some embodiments of the invention.

Optionally, the analysis rules are used to assign a category to acquired data (e.g., based on data type, device status), which category may affect later handling of the data. Alternatively, a category may be determined, for example, based on the high-level instruction used to generate it.

In an exemplary embodiment of the invention, analysis rules indicate what to do if abstraction layer cannot meet all its requirements, for example due to limited CPU, memory and/or bandwidth (e.g., to or from the abstraction unit). Such rules can define, for example, relative priority of data types, of tasks and/or or task requesters (e.g., maintenance routines on the maintenance unit).

### Maintenance Rules

These rules are often not executed by the abstraction unit, but by a maintenance unit. In some embodiments of the invention, the abstraction unit and maintenance unit are housed in a single casing, for example, being distinct software modules. However, the rules as such may be part of the abstraction model, possibly being uploaded to the maintenance unit from the abstraction unit (or other unit) and/or downloaded to the abstraction unit from the maintenance unit (or other unit). Exemplary maintenance rules include rules that indicate states when a warning is to be transmitted to a human or machine controller, when the apparatus is to be shut down for safety purposes, when a maintenance procedure is to be carried out, a specific failure analysis tree and/or rules for detecting failures. A particular example of a (periodic) maintenance rule is: {read port status ONCE an hour, IF a port has a bit error rate of over 90 THEN disable that port}.

The analysis rules and the maintenance may depend on the value of a single property or way depend on values of a plurality of properties. In addition, a maintenance rule may compare between multiple devices and/or sites and/or executions of a command. It is noted that the higher a maintenance unit is in a hierarchy of a support network, the easier it may be for that unit to compare between devices.

In some embodiments of the invention, the rule types are differentiated by their action. For example, a maintenance rule may be defined to perform an action, while an analysis rule may be defined to return a value, for example whether the rule is violated or not or a calculated value. In some cases, a maintenance rule has no higher authority, so once a value is displayed or stored, there is no other rule to pass the value to. In a particular embodiment of the invention, a maintenance rule performs or generates a display that lists one or more actions that perform maintenance. An analysis rule will optionally be limited to collecting information and processing it, possibly carrying out actions, but only those limited to collecting data. This may allow analysis rules to reside in the abstraction layer unit and be relative maintenance method independent. Alternatively, a same type of rule may selectively return a value or not, for example processing rules. Alternatively or additionally, a rule may be characterized by whether it chains to a specific other rule (e.g., data collection rules can chain to processing rules) or not. In some cases, a rule may generally chain to a set of rules that are selected between, for example, based on a specific result, value or category. Attentively or additionally, a rule may be categorized by its execution location, for example, an analysis rule may execute at the abstraction unit or site server and a maintenance rule at a site server or a vendor server (described below).

### Storage Rules

Once data is acquired, it is generally stored. However, over time much data may accumulate. In an exemplary embodiment of the invention, storage rules are provided to define the type and/or extent of data stored. For example, a storage rule can indicate if data is to be stored and for what time period. Some data, for example, may be dropped immediately after it is analyzed. Other data may be stored until a next data is collected. In other cases, the collected data is stored optionally with a time stamp, permanently.

Alternatively or additionally, such a rule can define the form of storage, for example, raw data, processed data, statistical extraction (e.g., averages), items of interest (e.g., above a threshold) or general summary (e.g., a filled out form). Optionally, the storage rules define a security level and/or encryption. Alternatively or additionally, such a rule defines time-lines, for example, CPU load data may be stored raw for 7 days or 2 KB, daily averages for a month and only monthly averages after that. Alternatively or additionally, such a rule defines space utilization, such as relative priority of data, amount of storage to allocate for a certain type of data and/or what to do if there is a data overrun.

It should be appreciated that storage rules may be applied at the abstraction unit and/or at maintenance units. Optionally, stored data is associated with its governing rules, so that stored data can be compressed, encrypted and/or dropped, as defined by the rules.

### Display Rules

In an exemplary embodiment of the invention, rules are provided to define a preferred and/or default manner to display data, for example, a display format (e.g., chart and/or chart type, table, single number), what data to display simultaneously (e.g., two properties side by side), display of associated information (e.g., normal ranges) and/or update rate of information a display. A display rule may also indicate a limited number of options by which the data may be displayed.

The display rules optionally include display arrangements defined for showing the collected data at different occasions. For example, the displays may include daily reports, weekly reports, reports for specific, events (e.g., overheating), etc. The displays optionally define the arrangement for showing the data on a screen of site server 104. In some embodiments of the invention, the displays are activated responsive to a human trigger, event trigger and/or according to a predetermined timing scheme. Alternatively or additionally, one or more displays are linked to collection profiles, such that the displays are activated each time the data of the profile is collected.

### Other Rules

The above taxonomy of rule types reflects a particular modelization of devices, which may be suitable for some types of maintenance. For other tasks, devices and/or maintenance types, different sets of rules may be desirable. In general, in an exemplary embodiment of the invention, the rules flesh out the model structure so that it can represent a variety of devices to the maintenance provider, such that defining the maintenance of a device requires merely setting up several rules, which may optionally be copied from other devices, as described below. The differentiation between rules types may be based, for example, on different aspects of the model (e.g., data collection vs. storage) and/or on different data handling levels (e.g., collection vs. analysis).

Examples of additional rule sets not described in detail, include, rules for calibrating a device and rules for setting device parameters. In an exemplary embodiment of the invention, setting rules are similar to conversion rules, except that instead of asking for data and then sending an analysis rule to see if the data was returned, the setting rules send data and use an analysis rule and/or a later collection rule to see if the data was accepted by the device and utilized properly. A calibration rule may be a high level rule that collects data from the device, analyses it and generates device settings to be sent to the device. Another type of rule is a security rule (e.g., similarly, a privacy rule) which may act as a filter to prevent certain information from being sent out of the abstraction layer and/or modify the information (e.g., model number, number of ports). A security rule may operate on input data as well, for example to replace incoming instructions that refer to one type of device (e.g., with a certain number of ports) with another device. Optionally, certain devices may cause any information coring from them to be marked as “secure category”, to which security (or privacy) rules are applied. Alternatively, security rules may be drafted as other rules, such as conversion rules and analysis rules.

It should also be appreciated that some maintenance tasks may be defined by analysis rules. However, in some system implementations, it will be desired to separate out, to the extent possible, high level maintenance tasks from the abstraction layer, in which the rules will remain matched to a maintenance task which is performed by an external maintenance unit. This may assist in maintainability expandability and/or debugging.

### Rule Format

The term rule is used in the general sense that it defines what to do in certain cases. Various formats may be actually used, with some formats having an advantage of clarity, others of simplicity and others of power. In au exemplary embodiment of the invention, the rules can access an external function library to define their action, thereby providing potentially infinite extendibility and functionality.

In one example, a rule has the format of “if PATTERN then COMMAND(s)”, where if the pattern is matched, the commands are performed. Optionally, no flow control ability is provided within the commands. Alternatively or additionally, no local variables (as opposed to device property storage variables) are provided in the commands. Optionally, the commands may include the ability to select between alternatives (e.g., based on a value and/or an evaluated expression) and/or execute other rules (e.g., as a chain or as a subroutine).

In another example, the commands may be in the form of a general purpose script language, such as perl. Alternatively or additionally, a command may include some execution control ability, such as raising events (which may match patterns). It should be noted that virtual properties may inter-relate rules as may bookkeeping like rules, for example, rules that collect information (e.g., historical data) to be used by other rules.

Optionally, as noted above, Tales from different categories may be kited, for example, certain data processing rules to be performed after certain collection instructions and certain collection instructions to be carried out if an analysis rule fails.

### Categories

In an exemplary embodiment of the invention, another abstraction and/or organization tool is provided, categorization. Data is assigned a (one or more) category, which affects how the data is treated, for example, which rules are applied to it, its priority and/or how rules are applied (e.g., parameter settings). In an exemplary embodiment of the invention, a category determines how to store (e.g., for how long), display (e.g., chart or table) and/or analyze (e.g., trend analysis or threshold) the data. In an exemplary embodiment of the invention, the categorization is selected to match the task of maintenance (or other task performed by configuration 100). As a result of this application dependence, the delineation of categories and the categories themselves may be blurred, possibly with some overlapping.

Optionally, categorization is governed by a set of rules. Alternatively, categorization is included in other rules, for example, analysis rules.

In some embodiments of the invention, for each property, a category is defined, which category designates the major usage of the property. Optionally, the category is defined independent of instant the content of the property and/or generally to be shared by multiple properties that may belong to different objects. In an exemplary embodiment of the invention, the category is selected from configuration, calibration, inventory, status, performance, security, topology, accounting, events, alarms, operational and index. Different embodiments of the invention will possibly include only a subset or a different set of categories. In exemplary embodiments of the invention, categories are substantially fewer than properties (in relative and absolute terms) and are generally fixed for different device types.

Configuration properties optionally include properties that describe the system configuration (e.g., IP address). Changing these properties may be used to change the device configuration.

Calibration parameters optionally include parameters that define how the system is calibrated, for example, various corrections, interrupt vectors and buffer sizes.

Inventory properties optionally include properties that describe the devices software and/or hardware, for example, card serial number, card hardware version and/or identification of installed software packages.

Status properties optionally include properties that describe the device status, which are changed according to the operation of the device and/or its environment, e.g., whether a link is up or down.

Performance properties optionally include, for example, traffic counters, traffic statistics, CPU load and/or memory usage.

Security properties optionally include security state and problems of the device, for example, attempted break-ins and detected information leak.

Topology properties optionally include a connection configuration, for example, what devices are connected and using what type of connection.

Accounting properties are optionally related to usage and billing, for example, quotas and numbers of uses by a particular user.

Event properties optionally describe events of the device, such as event and alarm logs, SYSLOG logs and SNMP traps.

Alarms properties optionally relate to alarms generated by the device, for example, an out-of memory alarm or an oven temperature alarm. It should be noted that some alarm properties and/or other properties may be provided by the devices not in response to a request through the abstraction server. For example, in case of a failure of a device, the device (e.g., maintenance routines thereon) may send a failure message to the site server through the abstraction unit. In an exemplary embodiment of the invention, specific alarm handling rules are provided (e.g., as a set). Alternatively or additionally, a predefined set of processing rules and analysis rules is provided that is triggered by alarms, rather than other patterns. In one example, alarms are set and/or cleared by the device and are treated as objects. For example, a device can set an alarm “high bit error rate” and then clear the alarm once the error rate goes down. Optionally, the abstraction layer stores a history of these values and/or convert the event times to a time line that matches other historical variables.

Operational properties are often not used for maintenance purposes, except to ensure that a device is operational. Such properties may include, for example, a recording of a speech communication by a cellular telephone device.

Index properties are optionally used to identify a specific instance of an object (of which there are multiple). The use of properties in identifying specific instances of an object allows for differentiating between object instances, while using the same terminology in accessing all objects which are the same. Alternatively or additionally, any other method is used to differentiate between object instances.

In an exemplary embodiment of the invention, a calibration property is displayed as a table, analyzed to see changes, storage as changes, with a periodic complete calibration set. A performance property is displayed as a graph, analysis is by thresholding, storage is of complete data for a week and averages for the week before that.

In some embodiments of the invention, properties of a single category may be manipulated together, for example, be displayed and/or stored together, possibly using same or similar rules.

### Example of Adding a Device

Various details of the abstraction method may be made more clear by showing how a device is added to a support configuration 100. The device may be physically attached before, after and/or during the process, for example.

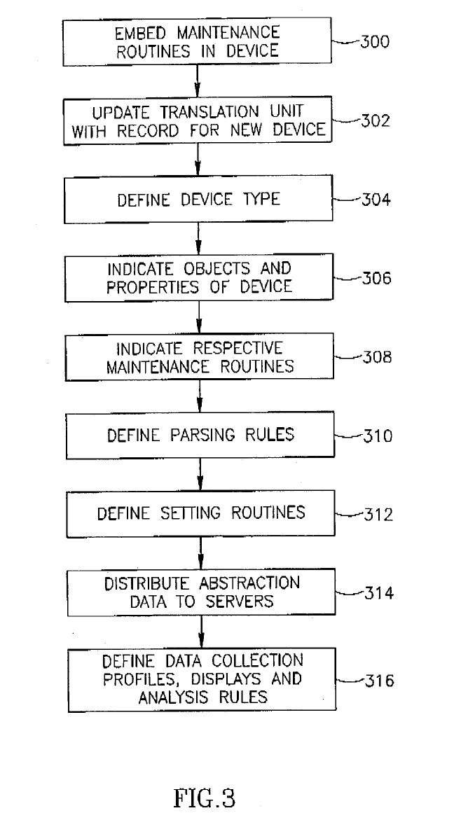

Reference is also made to FIG. 3, which is a flowchart of acts performed in preparing an embedded device 102 for monitoring in configuration 100, in accordance with an embodiment of the present invention.

During and/or at the completion of the manufacture of device 102 and/or at the installation of device 102 at a specific site, one or more maintenance routines 208 are optionally embedded (300) within the software code of device 102, as is known in the art. Optionally, each maintenance routine 208 relates to properties of a single object 204. Alternatively, one or more maintenance routines 208 may relate to properties of a plurality of objects 204 of a single device. Alternatively, any maintenance mode supported by device 102, for example a maintenance mode or SNMP-type maintenance may be utilized in the present invention, for example using suitable rules.

Translation unit 108 is then optionally updated (302) with a record for the new device. The update (302) optionally includes defining (304) the device type, for example its product line, model and version. In addition, the update (302) optionally includes indicating the objects (306) of the device along with the properties of each object. For each property, a maintenance routine 208 which collects data of the property is indicated (308), along with a parsing rule (310) on how to retrieve the value of the property from the gathered data. Optionally, for properties which may be set from site server 104, a maintenance routine to be used in such setting is defined (312), along with the data structure to be used. In an exemplary embodiment of the invention, for example as described below, at least some of the properties and/or objects of the device are self-learned by the maintenance unit and/or abstraction unit.

After translation unit 108 is updated (302), the abstraction data of the embedded device is distributed (314) to site server 104, which data is used to control the defined embedded device. In some embodiments of the invention, translation unit 108 has a console through which the update (302) is performed. Alternatively or additionally, the update (302) of translation unit 108 may be performed through site server 104. In some embodiments of the invention, the update (302) is performed by a vendor site (not shown) at the the of production of the device 102. At installation of embedded device 102 at a specific site, the abstraction model 200 of the embedded device 102 is downloaded to site server 104.

In an exemplary embodiment of the invention, it is often the case that, once abstracted, the maintenance of a new device may be the same as that of an old device. For example, if a new model of all existing device is added, in which the difference is that the new model can use a faster protocol, only the collection rules need be updated. In other cases, the maintenance may be different. However, many parts of the maintenance rules and/or decision trees may be the same and they are optionally copied.

Based on abstraction model 200 of the device, data collection profiles, analysis rules, displays and/or any other maintenance, logging and/or debugging acts are optionally defined (316) for the device. These acts may be defined together with abstraction model 200, optionally forming an integral portion of the model, or may be defined at a later time, for example at site server 104.

Referring in more detail to defining (306) the objects 204 of the device, in some embodiments of the invention, for each object a protocol (i.e., communication method) is indicated for communicating with the object. Optionally, several protocols are defined, possibly providing different protocols for different properties or even for a same property. Alternatively, a protocol is defined for each maintenance routine 208. Optionally indicating of the properties of the object is optionally performed by stating for each property, a name, a description, a category and/or a data type. The data type of the property is optionally selected to match the data type of the actual data represented by the property. In an exemplary embodiment of the invention, the data type may be a standard data type used in software programs, for example, integer, string, enum, IP address, float, user defined and compound data structures. Optionally, default data types can be defined per device, with the processing rules converting to these data types. Optionally, when a user defined data type is provided, conversion rules are provided with the data type definition. Other items may be provided as devices defaults, for example, rules.

In an exemplary embodiment of the invention, the use of the abstraction methods is useful when upgrading parts of the system, for example, providing backwards compatibility to older devices, while enhancing the system abilities. For example, if a new maintenance function is defined for advanced cellular telephones, also older cellular telephones may benefit from the maintenance function, by various of the functions that are expected to be performed by the advanced cellular telephones being actually performed (or fudged) by the abstraction layer, for example, gathering historical data. The maintenance function, however, can be unaware of the type of telephone.

### Vendor Server

Referring back to FIG. 1, in an exemplary embodiment of the invention, one or more remote vendor servers 106 are provided. Vendor server 106 may communicate directly with device 102 and/or indirectly, for example via site server 104. In an exemplary embodiment of the invention, vendor server 106 provides device specific maintenance routines, to be performed by device 102, site server 104 and/or vendor server 106. For example, this allows a vendor of embedded processor 102 to provide on-line maintenance, debugging and/or logging services for embedded processors it supplied. In the embodiment shown in FIG. 1, vendor server 106 communicates with processor 102 through site server 104, online and/or off-line. It is noted, however, that vendor 106 may communicate directly with embedded device 102. Optionally, vendor site 106 has a respective abstraction translation unit.

In general, the vendor server can perform the same type of activities as a site server, for example, ask for and receive data, set and execute rules and/or be a source of alerts. In an exemplary embodiment of the invention, the vender server is vendor specific, and it may be more focused on only a more limited subset of devices. Alternatively, a vendor server or comparable server is provided by a large service provider and/or maintainer, for example, a large carrier. Such a “vendor server” may thus provide multi-vendor services. In an exemplary embodiment of the invention, the vendor station contains knowledge used by all the support networks and serves as a source for distributing this knowledge.

It should be noted however, that vendor server 106 is often better situated to do comparative testing and analysis between devices.

### Complete Exemplary Vendor-Server Based Maintenance System

An exemplary maintenance system contains of a vendor server, a plurality of site servers and a plurality of embedded devices. For each device kind the vendor server stores maintenance routines and/or other information, which may be distributed to the site servers. Using this information a site server can detect for each device its abstraction model type, collect information according to the detected abstraction model, execute analysis rules and perform an action based on the result of the analysis rules execution. The action can be, for example, the execution of another maintenance routine. In this manner, a maintenance decision tree can be implemented (e.g., a troubleshooting guide or a proactive maintenance guide: “Run command X. If you see Z then run A. At the end run Y”).

It should be noted that the decision-tree leaves do not necessarily represent result of an analysis but often represent data collected from the device. One reason for this is that for complex devices it is not always possible to find a common (for several problems) troubleshooting routine with a solution at the end. Very often the common part of troubleshooting routine is not a solution but data collection in a manner that will make finding a solution easier. After the data is collected and analyzed the site server can send it back to the vendor server and/or trigger an action (such as additional data collection or analyzing). The vendor server can, for example, save, display and/or analyze the data, optionally using maintenance personal.

In an exemplary embodiment of the invention, the system can support thousands of site servers and each site server can support thousands of devices. Optionally, the vendor server has a display that shows a world picture (e.g., global statistics and/or geographic information) and a display capability to drill down to each and every device and its properties. Every time the knowledge is updated at the vendor, a maintenance person or program optionally chooses a list of the site servers to update the knowledge. In an exemplary embodiment of the invention, the knowledge setup is facilitated by collecting pieces of information into abstraction Packages (possibly similar to like MIBs in the SNMP) and use those packages as building blocks to construct new Abstraction Model types and/or variations.

Alternatively or additionally, an inheritance tool is provided, which may assist in defining abstraction models, for example, a new model of a device (e.g., hardware and/or software upgrades and/or parameter settings initiated by configuration 100). For example, one entity may inherit (and optionally replace) some of predefined display, analysis and storage rules, from another entity in the abstraction layer.

### Operational Example

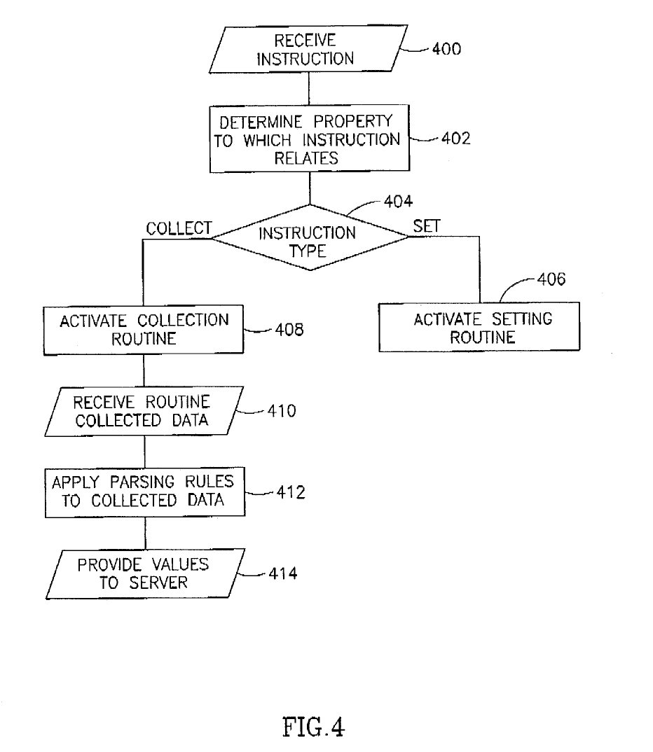

FIG. 4 is a flowchart of acts performed by translation unit 108 during operation, in accordance with an embodiment of the present invention. A site server determines that certain data should be collected and issues instructions to that effect. Upon receiving (400) an instruction from site server 104, translation unit 108 determines (402) the property (or properties) to which the instruction relates. If (404) the instruction relates to setting a property value, a maintenance routine 208 to be used in setting the property is activated (406) with the required value to be set. If (404) the instruction relates to collecting data, the maintenance routine 208 to be used to collect the values of the properties in the instruction are activated (408). Upon receiving (410) the results of the activated routines 208, the parsing rules of the properties required are applied (412) to the received data and the resultant property values arc provided (414) to site server 104 and/or a vendor server. In this example, the data is not analyzed, however, such analysis may be performed, for example as described herein.

In some embodiments of the invention, the instruction may be a procedure activation command, which activates one or more maintenance routines 208. Optionally, translation unit 108 includes a translation object, such as a table, which matches high level, maintenance commands to the actual low level maintenance routines 208. The use of abstraction translation unit 108, in accordance with some embodiments of the invention potentially allows defining a large number of different maintenance commands based on a limited number of maintenance routines 208, which do not take up a large amount of memory space on embedded device 102.

Optionally, a single instruction to translation unit 108 may relate to a plurality of different objects 204 and/or devices 102. For example, a single instruction may request to collect data from all the objects of a specific type. Alternatively or additionally, site server 104 stores command batches for activating sets of maintenance routines 208, which may be easily activated by maintenance personal.

In some embodiments of the invention, a user may bypass translation unit 108 and access the maintenance routines 208 of device 102 directly, for example, using a scripting language. This option may be used to achieve higher control of the maintenance routines in device 102. Optionally, the bypass commands do not pass through translation unit 108. Alternatively, the bypass commands are transferred by translation unit 108 without unit 108 relating to their content, except optionally, noting that they happened and/or recording the results, possibly for the sake of raising an alarm or using the data as historical data or for analysis. Further alternatively or additionally, a user may generate hybrid commands which partially use the abstraction scheme and partially access the maintenance routines 208 directly. In an exemplary embodiment of the invention, such a hybrid command is implemented by using an external library which is linked to the rules and including instructions to execute the routines (and, optionally handle the returning data) in the library. Thus, the standardized form of the rules is not affected. In another example, a user writes commands to analyze data returned by device 102 and ignored by the abstraction unit, for example, as not being the subject of a request. Such commands may be written as self-tiggering processing and analysis rules (e.g., triggered by the arrival of data from a device, not by a collection command).

### Dynamic Indexes

As noted above, a single object and/or property may exist multiple times for a single device, for example, a single device often has multiple ports. In an exemplary embodiment of the invention, these multiple instances are managed using indexes. Optionally, however, the indexes are not dealt with by a user. Instead, the system (e.g., the abstraction unit) creates the indexes as needed and refers to them as needed. In an exemplary embodiment of the invention, the system also determines the content of the indexes. For example, if a user requested a port summary, the abstraction layer asks the device for a list of ports, associates each one with an index and then for each port asks for various data, such as status. Any failed request is optionally treated separately by the abstraction unit, for example, attempting a repeat request. Thus, when a user writes the rules, he is only required to deal with the complexity of a single port or define global instructions for a port list, when the object is a report on all the ports. Similarly, the maintenance unit is also unaware of the number of ports (unless it asks for them specifically). Another example is CPU usage. The fact that a device has multiple CPUs may be transparent to a user and to a maintenance unit, by the abstraction layer requesting the CPU load for each processor in response to an aggregate command and returning an aggregate answer.

### Collection Optimization

It is expected that in some configurations there will exist multiple, apparently functionally equivalent, methods of collecting certain information from devices. In an exemplary embodiment of the invention, a human an selects which method to apply. Alternatively, the system provides an automatic algorithm for selecting a collection method. In one example, the collection methods are used, possibly randomly, and various statistics are collected, for example failure rates, adverse effects and/or other properties. After a time, each method is associated with an appropriate score, and a winning method chosen In some cases, different situations will favor different methods. In an exemplary embodiment of the invention, the same analysis software used to assess failure states and their causes is used to select which method is preferred.

Optionally, when there is multiple data to be collected, the abstraction unit decides ad hoe which method to use, for example, based on the method which will use the smallest overall bandwidth (e.g., in return values) or the method which will require fewest calls to the device. This problem may be solved, for example using linear programming methods known in the art, although many other methods are known as well.

### Communication Methods

While configuration 100 is generally a network, some embodiments of the present invention are generally neutral to the communication method and protocols used in the network. The communication between site server 104, vendor server 106 and devices 102 may be performed using any suitable method known in the art, including for example over the SNMP, Telnet, FTP, TL1, HTTP, Syslog, XML, proprietary and/or e-nail protocols, depending on the ability of the devices and/or units to support the protocols. As noted above, different properties of a same device can use different protocols for collection. In some embodiments of the invention a gateways for converting between protocols may be provided, for example, as a separate unit and/or embedded in one or more of the units or devices. The communications may use secure protocols (e.g., SSL) or may be insecure. The communications between site server 104 and vendor server 106 may use the same or different protocols as the communications with embedded device 102. In some embodiments of the invention, only a single communication method is used for the communication between site server 104 and embedded device 102. Alternatively, different communication methods may be used for different data or for different types of data. Further alternatively or additionally, a plurality of communication methods may be used, for example, for redundancy purposes.

### User Interface and Definitions

In an exemplary embodiment of the invention, a non-programmer user interface is provided to allow a user to perform various activities, for example, adding a device, performing maintenance, modifying settings and upgrading a device. As noted above, in an exemplary embodiment of the invention, some or all of these activities are automatic or semi automatic.

In an exemplary embodiment of the invention, when a user updates a device or installs a new device or a new device type, the user does not enter all of the device information. In one example, the system interrogates the device for at least some of the information. Alternatively or additionally, the user copies parts of device definitions, for example, rules for certain categories of information and maintenance scripts, from one or more previous devices and/or except libraries. In a particular example, rules for a power supply module, which was not updated, may be copied and/or linked to when a new device is added. A potential advantage of linking is ease of updating. However, it may have unexpected side effects. Optionally, when a rule or set of rules and/or other definitions are copied, an indication of the copying source is maintained so that automatic propagation of corrections to the source may be provided to the copies, if desired.

Once an excerpt is copied or inherited, the user may then edit a particular excerpt and modify it, for example, changing a collection rule. In an exemplary embodiment of the invention, the use of an organized hierarchical structure (e.g., FIG. 2 + the varieties of categories and rule types) reduces the number of rule inter-relationships, so that the task is simplified.

In an exemplary embodiment of the invention, the user selects rules and commands to apply from lists, for example, matching up a list of cases with a list of commands. In an exemplary embodiment of the invention, once a user defines a device type, the maintenance scripts for that device type are loaded. A user is prompted with a list of informational items required by the script, to which the user responds by indicating for each item a previously defined rules for collecting that item. Alternatively, a user may enter a new rule or rules, for example, by selecting from a list of available device maintenance calls and/or previously defined rules. In many cases, the call exists and what is required is parsing the returned data to extract a particular filed. Optionally, by indicating the field, the user causes the correct parsing rule to be generated. In some ceases, when a now device is provided, a programmer (e.g., a person that installs the hooks on the device, which may also be a computer) provides a list of the available maintenance routines and what each filed means. In many cases, the fields can be linked up automatically with the maintenance requirements. In others, a human may assist.

When a new maintenance rule is created, for example by human or by computer, if the information is available, rules for its collection may be automatically generated and/or copied. Otherwise, a user may indicate how to get the information and/or create new rules, for example analysis rules, to create the required information.

In an exemplary embodiment of the invention, updating of the system is enhanced by separating how data is collected from how the data is analyzed and/or used. Thus, one set of rules may be updated, possibly without requiring any, or only minor changes in the other sets of rules.

### Types of Devices

As noted above, device 102 can be of various types. In particular, device 102 can be a single device or an aggregate device. An exemplary aggregate device is an ATM switch, which includes many sub-components, each of which may be separately accessible. In an exemplary embodiment of the invention, such an aggregate device is represented as a hierarchical device, which may be addressed at several levels, for example, as a device as a whole and as sub devices. Each of these sub-devices may be a different entry for the maintenance unit. The hierarchy may be maintained, for example, by the maintenance unit, by the abstraction unit and/or by the device itself. Inter-relation between such sub devices may be provided, for example, using indexing (to link the sub devices) and using analysis rules that combine and/or compare data from device parts. Such a hierarchical structure may also be provided for a set of devices that is not physically integral, for example, a network, may be represented as a two or more level hierarchy, with the network as a whole being one device and each element of the network being a sub device. Rather than a pure hierarchy, also other arrangements, for example, graphs and forests may be provided, optionally, a single device, such as a gateway, may be included in two device hierarchies.

In some embodiments of the invention, a set of devices is defined as a virtual circuit which is treated as a device, some calls, such as “list of elements” may be emulated at the abstraction server. Others, such as round-trip testing may require synchronized commands to multiple ones of the devices in the virtual circuit. In an exemplary embodiment of the invention, the system is provided with various templates which a user can copy and use for such definitions.

In an exemplary embodiment of the invention, the use of an abstraction model allows a wide variety of embedded maintenance routines to be supported. Alternatively, if an abstraction model is used, the maintenance routines and methods may be adapted, for example, it provides an additional incentive to keep the protocols and formats the same for objects and/or properties between devices, so that the associated rules can be copied between the devices.

### Maintenance Network Topology and Integration

FIG. 1 shows a simple topology, in which a plurality of devices are serviced by a single site server, which is attached to a single vendor server. In a particular embodiment of the invention, each site server serves one or more physical sites, with no connection between the site servers, except through a vendor server. This is not a limitation in some embodiments of the invention. For example, a single device may be connected to multiple site servers. A site server may be local to the devices or remote from them. Vendor servers may be connected directly to the devices. A plurality of vendor servers may be provided, each of which connects to multiple, overlapping site servers. Various exemplary maintenance topologies and maintenance servers are described in WO 01/59972, the disclosure of which is incorporated herein by reference, in which various optional additional support elements are described, for example monitoring stations and security related units. In addition, as noted, for example, various information may be collected through other network components, for example, NMS (network management systems) systems and cellular telephone central offices. Data collection may be initiated, for example, by a third party, by a device, by a site server, by an abstraction unit and/or by a vendor server.

In an exemplary embodiment of the invention, the support network described herein is spliced onto an existing networking configuration, rather than replacing it. In one example, the abstraction unit serves as a level in one branch of a hierarchical support network. In this example, the abstraction server is used to “convert” a set of heterogeneous devices into a single type of virtual device, thus simplifying the work of a maintenance server. This same server may continue to provide maintenance services for multiple different devices, with one of the device types being the virtual device.

In an exemplary embodiment of the invention, the design of the abstraction unit is open, to allow integration with existing systems, updating of the model and rules and/or interaction with various types of maintenance servers. For example, the maintenance system is a whole may be designed for integration with other standard systems, such as knowledge bases, solution search bases, CRMs and ERPs. In an exemplary embodiment of the invention, maintenance rules are copied and/or extracted from knowledge bases. Alternatively or additionally, processing rules are extracted from manuals and suggested solutions. Successful maintenance routines may be converted to a human readable format and posted to a suitable knowledge base. In another example, a user complains via a CRM, the problem is solved and the solution and/or other information communicated through the CRM.

Optionally, the abstraction server is hierarchical, for example, reflecting a hierarchical structure of the devices and virtual circuits is communicates with.

### Non-Monitoring Application Examples

The above described system and method is especially useful for maintenance related tasks such as monitoring. In particular, embedded devices can gain from the use of an exemplary embodiment of the invention, due to the generally idiosyncratic type of maintenance routines available, the large variety, the difficulty in changing the embedded devices and/or limited available processing power and/or memory of the emended devices. However, it may also be used for other types of commanding and/or controlling multiple devices, for example, for device and network calibration and/or configuration management (e.g., of a network of cellular telephones).

In one example, a system for embedded device calibration is provided. In an exemplary embodiment of the invention, the system differs from a maintenance monitoring system in its main usage. This system is used when one time calibration is needed. In some cases, the system is not required to work simultaneously with many different devices, but it should support plurality of different device types and operation versions (flows). For example the system can be used for device calibration in a quality assurance process or can be used when the device should be calibrated during the deployment phase. In a particular example, a TV seller sells televisions and uses this method to calibrate colors, brightness and/or other viewing properties, such as channel programming, in accordance with the needs of a customer. The method an be applied when the customers are at home, or prior to providing the TV, in groups or one at a time. Optionally, a customer call interact with the calibration process, for example, by punching telephone keys on an IVR system that controls the calibration process, to provide feedback on the results. Alternatively, a user interface is provided via or by a set-top box or embedded TV circuitry, using a remote controller, for example and the TV display as the interface hardware.

In another example, a system for network calibration is provided. Thus system can be used to calibrate systems more complex than a single device, for example, a network of devices of different types. In exemplary embodiment of the invention, the system is used to configure the devices so that the network performance will be maximal. To do so, each device has to have appropriate Abstraction Model in the system with appropriate maintenance routines that will allow the Site Server to collect the data as well as to control the devices in order to create maximal network performance. For example, a network optimizer can rum various tests as known in the art and determine suitable settings which are expected to have more optimal results. These optimal settings may be tried out and maintained if they provide acceptable results.

In addition, the software used for implementing an exemplary embodiment of the present invention may be used, with some modification, for radically different tasks, such as operating system device interaction, gateway translation and simulation, as it includes several modules, software code portions and/or software structures which may be useful in carrying out these tasks. This, however, is generally a property of all Von-Neuman machines, which can each perform all programming task, with suitable re-programming.

It will be appreciated that the above described methods may be varied in many ways, including, changing the order of steps and/or performing some steps in parallel. In addition, different apparatus arrangements may be used. For example, abstraction translation unit 108 may be a hardware unit separate from site server 104 or may be a software module running on site server 104 and/or on vendor server 106. It should also be appreciated that the above described description of methods and apparatus are to be interpreted as including apparatus constructed and/or programmed for carrying out the methods and methods of using the apparatus. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe a best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. An abstraction unit, comprising:
a conversion module adapted to translate general instructions, having a format that is independent of a target device model, to specific instructions for each of a plurality of different target device models, said module having at least one programmable and user accessible rule element which defines said translation; and
a presentation module adapted to receive responses from a plurality of said target devices, said module having at least one programmable and user accessible rule element which converts said responses into a standardized response format that is independent of the device model that sent the response.

2. A unit according to claim 1, wherein said presentation module comprises parsing rules that extract a desired item from said responses, to form said standardized response.

3. A unit according to claim 1, wherein said rule elements comprise sets of rule statements.

4. A unit according to claim 1, comprising a maintenance unit that performs maintenance on said devices through said abstraction unit by providing said general instructions and receiving said standardized response.

5. A unit according to claim 4, wherein said maintenance unit is implemented using maintenance rule statements.

6. A unit according to claim 1, wherein said presentation module categorizes said responses, according to their type, into a number of categories, said number being smaller than each of a number of said target device models and smaller than a number of different properties defined for the devices.

7. A unit according to claim 6, wherein said categories determine for a standardized response which of a plurality of sets of rules are applied to the response.

8. A unit according to claim 1, comprising an analysis module that analyses said standardized response to produce maintenance-related information.

9. A unit according to claim 8, wherein said analysis module generates at least some response data that is requested by said general instructions and not directly provided in said responses.

10. A unit according to claim 1, comprising a bookkeeping module for tracking device property values for said devices.

11. A unit according to claim 10, wherein said bookkeeping module generates dynamic indexes of elements of said target devices that have multiple instances in a target device.

12. A unit according to claim 11, wherein said bookkeeping module automatically updates a listing of said multiple instances.

13. A unit according to claim 1, comprising a storage module which stores data from at least one of said responses and said standardized response, responsive to at least one storage rule.

14. A unit according to claim 1, wherein said target devices are modeled by said unit as hierarchical devices, with sub-components which are allowed to be repeated between different devices.

15. A unit according to claim 14, wherein different sub-components are treated differently in said standardized response.

16. A unit according to claim 15, wherein different sub-components have different rules associated with them.

17. A unit according to claim 1, wherein said unit is adapted to connect to multiple target devices at a same local physical site as said unit.

18. A unit according to claim 1, wherein said unit is adapted to connect to multiple target devices at a physical site remote from said unit.

19. A unit according to claim 1, wherein said unit is adapted to connect to a remote maintenance server.

20. A unit according to claim 1, wherein said unit is adapted to connect to a remote vendor server that accesses only devices from a limited number of device manufacturers.

21. A unit according to claim 1, wherein said unit is adapted to simultaneously serve multiple target devices belonging multiple device families.

22. A unit according to claim 21, wherein said unit is adapted to connect to at least 3 different device family types.

23. A unit according to claim 21, wherein said unit is adapted to connect to at least 5 different device types.

24. A unit according to claim 21, wherein said unit shares at least one rule between said multiple target devices.

25. A maintenance device system, comprising:
a plurality of target devices;
at least one abstraction unit according to claim 1, physically locally situated at a same site with respect to said plurality of devices; and
at least one maintenance server physically remotely situated at a different site with respect to said abstraction unit and configured to provide maintenance services to said target devices via said abstraction unit.

26. A system according to claim 25, comprising at least one vendor server configured to communicate with multiple abstraction units in multiple sites.

27. A system according to claim 25, wherein said maintenance server is configured to provide maintenance services to multiple remotely located sites.

28. A method of maintaining a plurality of objects, comprising:
generating maintenance instructions using a maintenance unit that models devices as abstract devices; and
converting said instructions into device specific instructions using an abstraction unit that views said devices as specific devices.

29. A method of adding a device to be maintained, to a maintenance system, comprising:
identifying a device type of said new device to be added;
copying at least one abstraction rule from an existing device rule set portion to a rule set portion of a representation of said new device; and
amending said rule set of said new device for said specific device after said copying.

30. An abstractive maintenance system, comprising:
an automated maintenance providing unit that models devices as abstract devices; and
an abstraction unit that models said devices as specific devices and interfaces between said devices and said maintenance unit.
